(19) United States
(12) Patent Application Publication
(10) Pub. No.: US 2022/0304503 A1
(43) Pub. Date: Sep. 29, 2022

(54) HANDLING DEVICE FOR FRIED FOOD

(71) Applicant: Benno KUTTRUFF, Hüfingen (DE)

(72) Inventor: Benno KUTTRUFF, Hüfingen (DE)

(21) Appl. No.: 17/616,850

(22) PCT Filed: Jun. 5, 2020
(86) PCT No.: PCT/EP2020/065573

§ 371 Date: Dec. 6, 2021

(30) Foreign Application Priority Data
Jun. 7, 2019 (DE) 20 2019 103 217.0

(51) Int. Cl. A47J 37/06; F24C 15/14

(52) U.S. Cl. CPC A47J 37/06; F24C 15/14

(57) ABSTRACT

The present invention relates to a handling device for roasted food, having a support sheet (12) for placing roasted food thereon, and a tray (14), especially for catching the roasting juice given off by the roasted food, wherein the tray (14) comprises a tray bottom (16), a wall (18) surrounding the tray bottom (16), and an outlet device (24), the outlet device (24) being situated in or on the wall (18), the outlet device (24) comprising an outlet tube (34) having a first end (36) and a second end (38), and in the region of the first end (36) or the second end (38) of the outlet tube (34) there is arranged a closure cap (48), which is movable into an open position for opening the outlet tube (34) and into a closed position for closing the outlet tube (34).

The invention relates to a handling device for roasted food.

Traditionally, oven sheets are used for the handling of roasted food when roasting food in an oven. In the case of certain foods, especially meat, a roasting juice is formed during the roasting, which collects on the oven sheet. This roasting juice is often used later on during the meal preparation. Especially when poultry is being roasted, the roasted food is basted with the roasting juice at regular intervals during the roasting process, in order to achieve an especially crispy roasted product. Moreover, the roasting juice is often used as gravy or the base for gravy, which is consumed later on with the roasted food.

In all cases where the use of the roasting juice will occur, however, the roasting juice must first be caught and collected. If a traditional oven sheet is used, the roasting juice emerging from the roasted food is distributed largely over the entire oven sheet, so that a large portion of the roasting juice is evaporated.

Furthermore, the roasting juice must be poured into a vessel for later use. Because of the large area of distribution of the roasting juice on the oven tray and the large degree of evaporation, however, the fill level is very low. Therefore, the roasting juice can only be removed with difficulty and to a limited extent from the oven try, for example by using a spoon or ladle. Due to the sometimes very large and heavy roasted food which is present on the oven sheet, pouring off the roasting juice into a vessel is really no alternative. Furthermore, there is a significant danger of being burned by the oven sheet as well as the surrounding parts of the oven, to say nothing of the roasted food and the roasting juice itself.

In the prior art, various approaches are found for the draining and/or catching of the roasting juice. In particular, one may cite in this regard the documents EP 2 702 911 A1, WO 2016/075119 A1, EP 1 459 664 A1 and U.S. Pat. No. 6,362,458 B 1 as well as WO 2019/081267.

However, the solutions presented in the cited prior art for the draining and/or catching of the roasting juice formed are characterized as being unsafe to handle and/or technically complex and therefore fault-prone and costly in maintenance and cleaning. In particular, the technical complexity moreover leads to large manufacturing costs.

Therefore, the problem which the invention proposes to solve is to provide a handling device for roasted food which makes possible a simple and safe draining and catching of the roasting juice and which at the same time is easy and effective to clean and easy to manufacture.

The problem is solved according to the invention by a handling device for roasted food having the features of patent claim 1.

Advantageous embodiments and modifications of the invention are indicated in the dependent claims.

A handling device for roasted food according to the invention comprises a support sheet for placing roasted food thereon, and a tray, especially for catching the roasting juice given off by the roasted food. The tray comprises a tray bottom, a wall surrounding the tray bottom, and an outlet device, serving especially for draining the roasting juice. The outlet device is situated in or on the wall and it comprises an outlet tube having a first end and a second end. Preferably, the outlet device is arranged on the wall such that the outlet tube is joined firmly to the wall, especially by a welded connection.

Thanks to situating the outlet device on the wall, the outlet device is advantageously situated on the side and especially at the front of the handling device. The liquid present in the tray can thus be drained from the tray at the side and especially at the front, through the wall and not through the tray bottom. In this way, advantageously, there is enough space between the outlet device and the kitchen counter so that a vessel for catching the liquid can be arranged with no problem beneath the outlet device.

In the region of the first end or the second end of the outlet tube there is arranged a closure cap, which is movable into an open position for opening the outlet tube and into a closed position for closing the outlet tube.

Usually the support sheet is arranged about the tray, so that the roasting juice given off by the roasted food located on the support sheet can flow by gravity downward into the tray. The tray is advantageously surrounded by the wall on its entire circumference. Preferably, the support sheet and the tray are configured such that the support sheet can be set down on the wall of the tray. Advantageously, the support sheet is adapted to the try, for example by an encircling flattened rim, so that the support sheet is centered by the wall of the tray or secured to the wall, preventing the support sheet placed on the tray from slipping.

The tray and the support sheet are advantageously made from enameled carbon steel.

The wall advantageously comprises a wall opening, in or on which the outlet device is arranged, especially the outlet tube. Preferably, the wall opening is arranged at the point of the wall located at the lowest point of the tray when the handling device is used as intended.

The closure cap is advantageously situated in the region of the first end on the outlet tube. In the closed position, the closure cap closes the outlet tube. In the open position, the closure cap is preferably arranged such that the outlet tube can receive a flow, especially a flow of liquid, such as roasting juice.

In one advantageous embodiment of the invention, the closure cap is arranged on the outlet tube such that it can be removed, or pulled off especially preferably. In this way, the closure cap can be mounted and removed especially easily, in particular to make possible an uncomplicated and thorough cleaning of the handling device. Moreover, the closure cap advantageously comprises an activating device, such as a lever, in order to assure the safest possible activation of the outlet device. The closure cap is advantageously made of heat-resistant polyphthalamide (PPA).

The closure cap and the region in which the closure cap is situated may be configured such that an outlet tube opening is freed up by rotational and/or translational movement of the closure cap into the open position. The outlet tube opening may be the cross sectional opening at the first or second end of the outlet tube. Likewise, the outlet tube opening may be formed by an opening in the envelope surface in the region of the first or second end of the outlet tube.

Especially preferably, the closure cap comprises at least one closure opening, which frees up the outlet tube in the open position of the closure cap. The closure opening can be aligned at least partially with the outlet tube opening. Furthermore, the closure cap may have an outlet tongue, which is arranged as a projection on the closure opening. In this way, a clean outflowing of liquid from the closure opening can be achieved. In particular, an uncontrolled back flow of liquid emerging from the closure opening onto the closure cap and a resulting soiling can be prevented.

In one preferred embodiment of the invention, a cover having at least one cover opening is situated in the region of that end of the outlet tube where the closure cap is situated. In this way, the cross section of the outlet tube opening can be reduced, making possible a reduced and thus better controlled volume flow for liquid flowing out from the outlet tube. The cover can thus contribute significantly to the safe operation of the handling device.

Especially preferably, the cover is arranged on a sleeve, which can be pushed onto the outlet tube or pushed into the outlet tube. The cover and the sleeve are advantageously formed as a single piece. In particular, if the sleeve is made from an elastic material, an especially good tightness can be achieved at the interface of outlet tube and sleeve. Thanks to the arranging of the cover on the sleeve, an easy mounting and removal of the outlet device can be achieved, which is advantageous in particular in regard to the cleaning of the handling device. Preferably, the sleeve is made of heat-resistant polyphthalamide.

Advantageously, the cover comprises a recess surrounding the cover opening, in which a sealing element is arranged. The sealing element preferably lies against the inside of the closure cap. In this way, a seal can be achieved between the cover and the closure cap. In particular, in the closed position the liquid can be prevented from emerging through the cover opening and collecting in the closure cap, or even escaping uncontrollably from the closure cap. The sealing element can be made from heat-resistant silicone, for example.

In one modification of the invention, the outlet device is designed such that the closure cap is arranged movably on the sleeve, for example by being pushed onto the sleeve. Preferably, the sleeve has a shoulder, on which the closure cap can be locked. For this, the closure cap may have pin-shaped detent elements or an undercut, for example.

The sleeve can have at least one guide groove and the closure cap at least one stopping means engaging with the at least one guide groove. In a reverse arrangement, the closure cap can have at least one guide groove and the sleeve at least one stopping means engaging with the at least one guide groove. Thanks to such an arrangement, the movement of the closure cap relative to the sleeve can be limited. The stopping means may be designed as a pin, for example. Preferably, the at least one guide groove and the stopping means define three positions between which the closure cap on the sleeve can switch by rotational and/or translational movement. Besides the open position and the closed position, the closure cap can be moved advantageously into a cleaning position, in which the closure cap can be removed for cleaning the outlet device.

In the open position, the at least one closure opening and the at least one cover opening advantageously overlap to the maximum degree. Hence, the maximum flow rate of liquid can be achieved. Thus, by the rotational and/or translational movement of the closure cap, the quantity of the volume flow emerging from the outlet device can be regulated.

According to one modification of the invention, the closure cap is situated in the region of the first end of the outlet tube and in the region of the second end of the outlet tube there is arranged a retention element, serving especially for catching larger particles contained in the roasting juice, such as pieces of the crust of the roasted food. For example, the retention element can be configured as a sieve or a filter. In particular, the retention element can serve for keeping the outlet device unclogged. Advantageously, the retention device is configured such as to cover the entire cross sectional surface of the wall opening.

The retention element may have special importance when the handling device is used in another form of application for steam roasting with aromatized steam. In this form of application, herbs and vegetables are arranged in the tray, for example, and water or wine is poured over them. When the handling device is placed in the oven and heated, aromatized steam can be produced in the oven, in which the roasted food arranged on the support surface is cooked. During such a use of the handling device, especially large particles are present in the tray, which need to be held back when the liquid is drained in the tray.

Preferably, the retention element comprises at least one holding element by which the outlet tube is arranged on the retention element. In a reverse arrangement, the retention element may be arranged on the outlet tube. This may be the case, in particular, when the outlet tube is firmly connected to the tray, especially when it is welded to the tray. The outlet tube may be connected to the separating element by material bonding, friction locking, or form fitting. Advantageously, detachable connections will be used, in order to assure an uncomplicated assembly and disassembly and thus an easy cleaning.

Especially preferably, the outlet tube and the holding element are joined together by friction locking. In this way, the outlet tube and the retention element can be especially easily mounted and removed. A frictional locking can be achieved, for example, by arranging two or more projecting, resilient holding elements on the separating element. Advantageously, these holding elements are materially bonded to the retention element. The holding elements may be arranged on the retention element such that they are oversized in relation to the internal diameter of the outlet tube. When the outlet tube is pushed onto the holding elements so arranged, the holding elements will be advantageously pretensioned so that they press from the inside against the internal diameter of the outlet tube and produce a frictional locking to the outlet tube.

Advantageously, the retention element is arranged on the inside of the wall. In such a modification of the invention, the holding elements will be led through the wall opening of the wall to the outside of the tray. From the outside of the tray, the outlet tube and the components arranged on it can then be pushed onto the holding elements and be connected by friction locking to the holding elements and thus to the retention element. Preferably, the outlet tube will be pushed onto the holding elements far enough so that it lies against the outside of the wall or protrudes slightly through the wall opening into the tray.

Optionally, the retention element comprises a handle. The handle may be useful, in particular, when the retention element needs to be held or pulled from the inside of the wall, such as may be the case for example when removing the outlet tube or when pulling out the retention element. Also in cases when the retention element is heavily soiled or clogged, the handle may facilitate the handling of the retention element.

In one modification of the invention, the handling device comprises at least one foot having at least one support damper. Preferably, four feet are arranged on the handling device. The feet are advantageously long enough so that there is sufficient space beneath the tray and especially beneath the outlet device to place a vessel underneath, where the liquid present in the tray can be drained off. Furthermore, adequate length of the feet can ensure that the handling device may be handled safely by a user in the hot oven. One limiting factor for the length of the feet may be the height of the oven, in particular. Accordingly, the length of the feet will advantageously be chosen at most so long that the handling device can fit into the oven, even with relatively tall roasted food, such as a turkey.

Preferably, the handling device will be used for cooking the roasted food in the oven and for serving the roasted food at table. In particular for the purpose of serving, the handling device may have one or more support dampers. In this way, the supporting surface, such as a table, can be protected against damage, especially due to the heat of the handling device. Furthermore, the distance between the handling device and the support surface can be increased with the aid of the at least one support damper. This may make it easier to place a vessel underneath, such as a plate for catching the drained liquid.

Advantageously, the at least one support damper of the handling device is removable, especially for cleaning purposes. Preferably, the at least one support damper is made from heat-resistant silicone.

In one modification of the invention, the support sheet is configured as a perforated sheet. The support sheet in this case has at least one hole. Advantageously, the support sheet is configured such that a plurality of holes are arranged over the major portion of the surface of the support sheet, so that many holes are located beneath the roasted food arranged on the support sheet. Through the holes arranged in the support sheet, the liquid given off by the roasted food can get into the tray arranged underneath the support sheet. A hole diameter of 2 to 5 mm has proven to be especially advantageous. With such a hole diameter, the liquid given off by the roasted food can easily flow through the holes into the tray situated underneath. At the same time, the liquid already present in the tray can be protected to a large extent from evaporation. The volume of liquid collecting in the tray can be increased significantly by means of the perforated sheet as compared to the oven sheets disclosed in the cited prior art.

Preferably, the support sheet additionally has holes of larger diameter, which are situated in the rim and/or corner regions of the support sheet. Such holes may be especially advantageous when using the handling device for especially large roasted food, such as turkey, reaching up to the rim of the support sheet. The centrally located holes are thus often closed, at least partially. When cooking such roasted food, a lot of liquid may furthermore be produced. Thanks to the holes of larger diameter in the rim and/or corner regions, the resulting liquid can still flow fast enough into the tray, so that no intensified evaporation effect will occur.

In one modification of the invention, the handling device comprises an inserting device for inserting into an oven. Especially preferably, the inserting device is designed as a fold, being situated at least on two opposite sides of the tray. Advantageously, the handling device can be inserted into the insert slots of a conventional oven by means of the inserting device.

An exemplary embodiment of the invention will be explained with the aid of the following figures. There are shown:

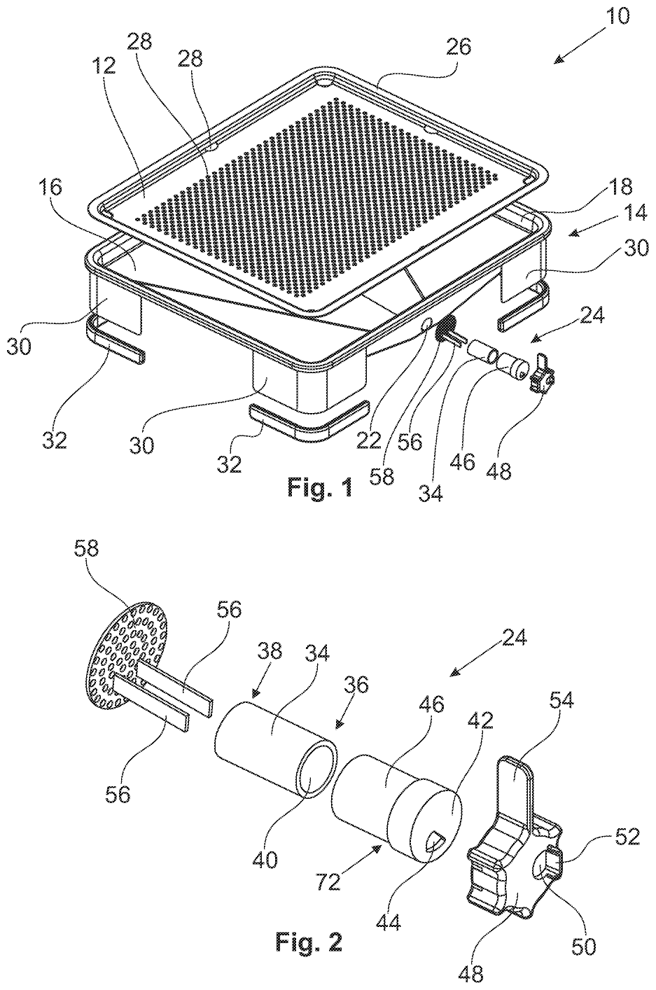

FIG. 1 an exploded view of a first exemplary embodiment of a handling device according to the invention,

FIG. 2 an exploded view of the outlet device of the exemplary embodiment represented in FIG. 1,

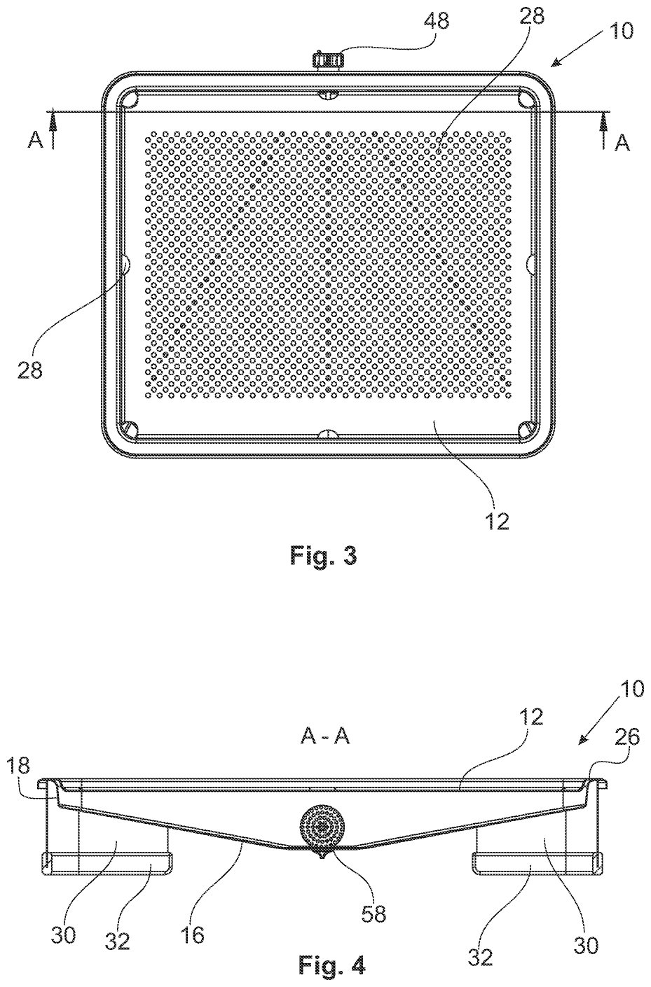

FIG. 3 a top view of exemplary embodiment represented in Figure indicating the cross sectioning plane A-A,

FIG. 4 cross sectional view A-A of the exemplary embodiment represented in FIG. 1 according to the cross sectioning plane indicated in FIG. 3,

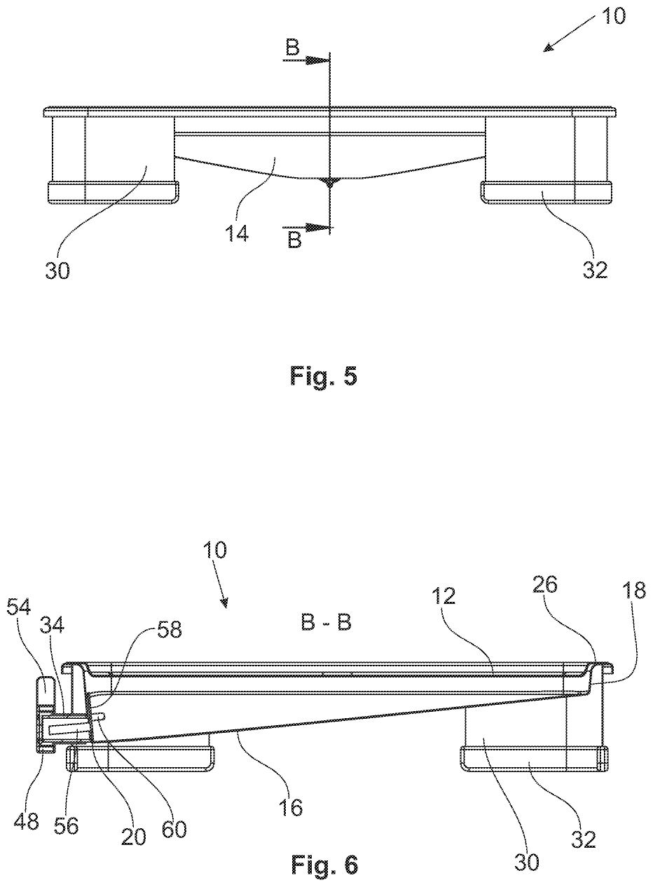

FIG. 5 a rear view of the exemplary embodiment represented in FIG. 1 indicating the cross sectioning plane B-B,

FIG. 6 cross sectional view B-B of the exemplary embodiment represented in FIG. 1 according to the cross sectioning plane indicated in FIG. 5,

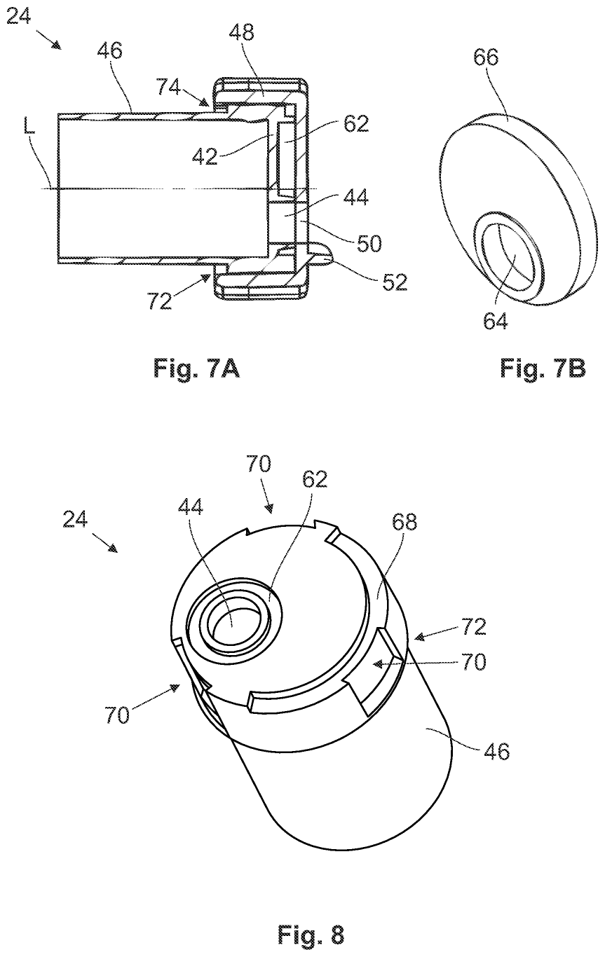

FIG. 7A a cross sectional view of part of the outlet device of a second exemplary embodiment,

FIG. 7B a projection view of the sealing element of the second exemplary embodiment represented in FIG. 7A, and

FIG. 8 a projection view of a sleeve of the outlet device of a third exemplary embodiment.

FIGS. 1 to 8 show various views of several exemplary embodiments. For sake of clarity, not all reference numbers are used in each figure. The same reference numbers are used for the same and functionally identical parts.

FIG. 1 shows an exemplary embodiment of a handling device 10 according to the invention. The handling device 10 comprises a support sheet 12 and a tray 14. The tray 14 comprises a tray bottom 16 and is bounded by an encircling wall 18. The tray bottom 16 is preferably formed as a trough, having a lowest point 20 when the handling device 10 is used in the intended position (see FIG. 6). Thus, liquid which is caught in the tray 14, especially roasting juice, can collect at a defined location in the tray 14. In the wall 18 there is arranged a wall opening 22, at which an outlet device 24 is arranged. The wall opening 22 and the outlet device 24 are situated in the region of the lowest point 20 of the tray 14. The tray bottom 16 is tilted toward the lowest point 20. Thus, the liquid collecting in the tray 14 can be removed entirely through the outlet device 24.

The support sheet 12 is arranged above the tray 14. As is seen especially in FIG. 6, the support sheet 12 for this purpose has an encircling, flattened rim 26, which lies against the wall 18. The play between the support sheet 12 and the tray 14 is preferably adjusted such that the support sheet 12 can be lifted off from the tray 14 without resistance. At the same time, the rim 26 may serve as a centering, so that only a minimal slippage of the support sheet 12 on the tray 14 is possible. The flattened rim 26 furthermore has the advantage that roasted food arranged on the support sheet 12 is prevented from slipping off the support sheet 12 when manipulating the handling device 10.

The support sheet 12 furthermore has a plurality of holes 28. As is shown in FIGS. 1 and 3, the holes 28 may be formed in various sizes. Advantageously, many small holes 28 are arranged in the central region of the support sheet 12, where the roasted food is usually positioned, so that a lattice-like structure is produced. In this way, the liquid given off by the roasted food can flow directly into the tray 14. The liquid can thus get into the tray 14 arranged beneath the support sheet 12 on the shortest possible path.

Thanks to the support sheet 12 arranged above the tray 14, the liquid present in the tray 14 is protected against evaporation. In order to achieve at the same time the most effective possible catching of the roasting juice and a good protection against evaporation, the holes 28 have a diameter of 2 to 3 mm. This hole size has proven to be especially advantageous in this regard. Furthermore, additional holes 28 are arranged along the edges and in the corners of the support sheet 12. Thanks to their position at the edge and in the corners of the support sheet 12, neither are they covered, even when cooking large roasted food. Due to their large diameter, they can ensure that even larger quantities of resulting liquid can flow swiftly into the tray 14. Thus, with the exemplary embodiment represented in FIGS. 1 to 6, up to three times more roasting juice can be obtained as compared to a traditional oven sheet.

The handling device 10 has four feet 30. The feet 30 are arranged directly on the tray 14 and joined to the tray 14 as a single piece. On each of the feet 30 there is arranged a support damper 32. The support dampers 32 are designed to be removable from the feet 30, so that they can be removed for cleaning purposes, for example.

A more detailed representation of the outlet device 24 is shown in FIG. 2. The outlet device 24 comprises an outlet tube 34 having a first end 36 and a second end 38. The outlet tube 34 moreover comprises an outlet tube opening 40, which in the present exemplary embodiment is formed by the cross section opening at the first end 36 of the outlet tube 34. In the region of the first end 36 of the outlet tube 34 there is arranged a cover 42, having a cover opening 44. The cover 42 is arranged on a sleeve 46, which is pushed onto the outlet tube 34. The cover 42 here lies against the outlet tube opening 40.

In the region of the first end 36 of the outlet tube 34 there is furthermore arranged a closure cap 48 with a closure opening 50. The closure cap 48 is arranged on the sleeve 46 such that the closure cap 48 can turn relative to the sleeve 46 about the longitudinal axis of the outlet tube 34. By turning it, the closure cap 48 can be arranged such that the cover opening 44 and the closure opening 50 are aligned. The closure cap 48 is then located in an open position.

The volume flow of liquid emerging from the outlet device 24 can be regulated by turning the closure cap 48 to adjust how much the cover opening 44 and the closure opening 50 will overlap. If the cover opening 44 and the closure opening 50 do not overlap, the closure cap 48 will be in a closed position. In the closed position, no liquid can emerge from the outlet device 24.

An outlet tongue 52 is arranged on the closure cap 48 in the region of the closure opening 50. The outlet tongue 52 enables a clean flow of liquid out from the closure opening 50. In particular, this can prevent an uncontrolled back flow of liquid emerging from the closure opening 50 onto the closure cap 48. A lever 54 is arranged on the closure cap 48 for easy and safe operation of the closure cap 48.

In the region of the second end 38, the outlet tube 34 is arranged on the wall 18, especially at the wall opening 22. The outlet tube 34 in this case is welded to the wall 18. A retention element 58 is arranged on the outlet tube 14, on which holding elements 56 are arranged. The retention element 58 is held by the holding elements 56 on the outlet tube 14. The distance between the outer edges of the two holding elements 56 is somewhat larger than the internal diameter of the outlet tube 34, so that the holding elements 56 when pushed into the outlet tube 34 are slightly deformed elastically in the direction of the middle of the outlet tube 34. In this way, the holding elements 56 act like pretensioned spring elements, which press against the inner wall of the outlet tube 34 and thus produce a friction locking with the outlet tube 34.

As is shown in the cross section representations of FIG. 4 and FIG. 6, the retention element 58 is arranged in the tray 14 on the inside of the wall 18. The dimensions of the retention element 58 are chosen such that the retention element 58 covers the entire wall opening 22.

The retention element 58 is configured as a sieve, so that particularly large particles can be held back in the tray 14. In this way, a clogging of the outlet device 24 can be prevented. This is especially relevant when the handling device 10 is being used for cooking with aromatized steam. In order to create the aromatized steam, herbs and vegetables for example are placed in the tray 14 along with water or wine. So as not to impair the functionality of the outlet device 24 when draining off the resulting gravy, large particles can be caught by the retention element 58. For better handling, especially when pulling off the frictionally locked outlet tube 34 and/or when especially soiled, the retention element 58 has a handle 60.

It becomes clear, especially from FIGS. 1, 2 and 6, that the handling device 10 shown, and especially the outlet device 24, consists of few individual parts, which are joined together in particular by plug-in connections. In this way, the handling device 10 can be easily assembled or disassembled without special tools. This is especially advantageous, since in this way the handling device 10 can be thoroughly cleaned with little effort.

FIG. 7A shows a second exemplary embodiment of the outlet device 24 with the aid of a cross sectional representation. Unlike the cover 42 of the sleeve 46 as represented in FIG. 2, the cover 42 in the second exemplary embodiment has a recess 62, in which a disc-shaped sealing element 66 can be inserted, being represented in FIG. 7B. The sealing element 66 has a through opening 64, which surrounds the cover opening 44 in the mounted state. The sealing element 66 produces a sealing action for the cover 42 relative to the closure cap 48.

FIG. 8 shows in perspective view a sleeve 46 of an outlet device 24 according to a third exemplary embodiment, looking at the cover 42. The recess 62 is situated around the cover opening 44, being configured in this exemplary embodiment such that the sealing element 66 not represented here can be designed as an O-ring.

Furthermore, it can be seen from FIG. 8 that the sleeve 46 has a guide groove 68 in the region of the cover 42. The closure cap 48 engages with the guide groove 68. The guide groove 68 defines the open position and the closed position in that the closure cap 48 is stopped against the respective ends of the guide groove 68, for which purpose the closure cap 48 is provided with stopping means, not seen here.

It can be seen from FIGS. 2, 7A and 8 that the sleeve 46 has a shoulder 72, thereby producing a region with an enlarged diameter leading toward the cover 42, on which the closure cap 48 is mounted. Furthermore, the sleeve 46 has a total of three recesses 70 distributed evenly over the circumference, running substantially parallel to the longitudinal axis L of the sleeve 46. The closure cap 48 can have three projections 74 pointing radially inward, which engage with the recesses 70 in a corresponding rotary position, so that the closure cap 48 is pushed onto the sleeve 46 until the closure cap 48 lies against the sleeve 46 and against the sealing element 66. If the closure cap 48 is moved from this rotary position, the closure cap 48 will grasp the shoulder 72 with the projections 74 such that the closure cap 48 interacts in form fitting with the sleeve 46.

### LIST OF REFERENCE NUMBERS

10 Handling device
12 Support sheet
14 Tray
16 Tray bottom
18 Wall
20 Lowest point
22 Wall opening
24 Outlet device
26 Rim
28 Hole
30 Foot
32 Support damper
34 Outlet tube
36 First end
38 Second end
40 Outlet tube opening
42 Cover
44 Cover opening
46 Sleeve
48 Closure cap
50 Closure opening
52 Outlet tongue
54 Lever
56 Holding element
58 Retention element

### 60 Handle

62 Recess
64 Through opening
66 Sealing element
68 Guide groove
70 Recess
72 Shoulder
74 Projections
L Longitudinal axis

1. A handling device for roasted food,
having a support sheet (12) for placing roasted food thereon, and a tray (14), especially for catching the roasting juice given off by the roasted food, wherein
the tray (14) comprises a tray bottom (16), a wall (18) surrounding the tray bottom (16), and an outlet device (24), especially for draining the frying juice,
the outlet device (24) is situated in or on the wall (18),
the outlet device (24) comprises an outlet tube (34) having a first end (36) and a second end (38), and
in the region of the first end (36) or the second end (38) of the outlet tube (34) there is arranged a closure cap (48), which is movable into an open position for opening the outlet tube (34) and into a closed position for closing the outlet tube (34).

2. The handling device for roasted food according to claim 1, characterized in that the closure cap (48) comprises at least one closure opening (50), which frees up the outlet tube (34) in the open position of the closure cap (48).

3. The handling device for roasted food according to claim 1,
characterized in that a cover (42) having at least one cover opening (44) is situated in the region of that end (36, 38) of the outlet tube (34) where the closure cap (48) is situated.

4. The handling device for roasted food according to claim 3, characterized in that the cover (42) is arranged on a sleeve (46), which can be pushed onto the outlet tube (34) or pushed into the outlet tube (34).

5. The handling device for roasted food according to claim 3,
characterized in that at least one closure opening (50) is aligned with at least one cover opening (44) in the open position of the closure cap (48).

6. The handling device for roasted food according to claim 3,
characterized in that the cover (42) comprises a recess (62) surrounding the cover opening (44), in which a sealing element (66) is arranged.

7. The handling device for roasted food according to claim 4,
characterized in that the closure cap (48) is arranged on the sleeve (46) movably in rotation and/or translation and the sleeve (46) comprises at least one guide groove (68) and the closure cap (48) comprises at least one stopping means engaging with the at least one guide groove (68), or vice versa, whereby the movement of the closure cap (48) relative to the sleeve (46) is limited.

8. The handling device for roasted food according to claim 1,
characterized in that the closure cap (48) is situated in the region of the first end (36) of the outlet tube (34) and in the region of the second end (38) of the outlet tube (34) there is arranged a retention element (58), especially for catching larger particles contained in the roasting juice.

9. The handling device for roasted food according to claim 6, characterized in that the retention element (58) comprises at least one holding element (56) with which the outlet tube (34) is arranged on the retention element (58) or vice versa.

10. The handling device for roasted food according to claim 7, characterized in that the outlet tube (34) and the holding element (56) are joined together by friction locking.

11. The handling device for roasted food according to claim 6,
characterized in that the retention element (58) is arranged on the inside of the wall (18).

12. The handling device for roasted food according to claim 6,
characterized in that the retention element (58) comprises a handle (60).

13. The handling device for roasted food according to claim 1,
characterized in that the handling device (10) comprises at least one foot (30) having at least one support damper (32).

14. The handling device for roasted food according to claim 1,
characterized in that the support sheet (12) is configured as a perforated sheet.
